(19) United States
(12) Patent Application Publication
(10) Pub. No.: US 2003/0227385 A1
(43) Pub. Date: Dec. 11, 2003

(54) Limited access article identifier and locator system and method

(76) Inventor: Cory L. Lancaster, Alpena, MI (US)

Correspondence Address: CORY L. LANCASTER, 241 N. LAWN ST., ALPENA, MI, 49707, US

(21) Appl. No.: 10/165,807

(22) Filed: Jun. 10, 2002

(51) Int. Cl. G08B 13/14

(52) U.S. Cl. 340/572.1; 340/825.49

(57) ABSTRACT

The system and method for locating building priority systems are disclosed. An EAS or RFID tag is applied to plumbing fixtures, heating units, hazardous materials, electrical junction boxes, outlet boxes and/or wiring systems within walls, floors, ceilings. A RFID reader sends an interrogation signal when scanned over walls, floors, or ceilings that causes the tag to emit a response signal. The RFID reader displays a LED and/or LCD readout to pinpoint priority systems for the purpose of residential, commercial, and industrial construction and maintenance that may not be visually obvious.

### CROSS REFERENCE TO RELATED APPLICATIONS

U.S. Pat. No. 5,859,587 U.S. Pat. No. 5,859,587 U.S. Pat. No. 3,810,147

### BACKGROUND OF INVENTION

This invention relates to electronic article identification devices and an associated system and method.

This invention is an electronic locator system using a combination of Electronic Article Surveillance (EAS) tags and Radio Frequency Identification (RFID) labels.

Electronic Article Surveillance systems wherein magnetic tags are attached to the articles under surveillance are well known in the art. In these systems, an alternating magnetic field is applied to an interrogation zone via an antenna system. If an article with an EAS tag passes into the zone, the presence of the tag in the zone causes a disturbance in the field. The field in the zone is sensed by a receiver antenna, whose output contains this disturbance. A detector analyzes the signal from the receiver and is activated indicating passage of the tag through the zone.

A Radio Frequency Identification label is a method of finding a specific article located in a plurality of articles. An RFID label contains stored data associated with that article and can generate a feedback signal to a handheld RFID reader. The feedback signal may be accompanied by audible sounds and/or a tactile vibration would further indicate location. Each RFID label includes an antenna for transmission of stored code within the tag and sensors for receiving codes transmitted by a reader.

A data communication and electronic article surveillance tag is a combination of the EAS and RFID tags. It is comprised of a housing made up of a first cover and a second cover. A data communication transponder and said electronic article surveillance tag are positioned in a cavity between said first and second covers. The data communication transponder contains a memory containing data about an article. An antenna is positioned between the covers.

This invention uses any or a combination of the above for the purpose of identifying and/or finding electrical boxes, plumbing fixtures, and other devices associated with the field of construction and industrial manufacturing.

Coded tags and/or labels installed at the time of construction or installation of electrical, plumbing, heating, etc. will enable users to quickly and easily locate marked systems within buildings.

The locator system employs a handheld scanning device programmed to locate the EAS tags and/or RF labels within building structures without destroying walls, ceilings or floors to find, repair or install wiring, heating or plumbing units used in residential, commercial and industrial construction.

EAS/RF tags/ilabels will work in any combination of the following four ways: 1: Color-coded 2: Icon 3: Frequency 4: Data Coded. Color-coding can be as follows: Blue: Plumbing/waterGreen: Electrical Red: Heat Orange: Hazard.

The tags/labels can be further sub-coded with icons of any description. The tags/labels can be used with a different frequency or data coded for each application. Both of these options can also be used in conjunction with the color-coding and the icons.

Radio Frequency Identification (RFID) utilizes radio frequency interrogation and reply frequencies to perform electronic article identification functions. RFID labels can store data, whereas the EAS tag only contains a magnetic signal. Tags or labels may be applied manually at a construction site or on a specific part by a manufacturer. Later, repair or maintenance personnel will easily find the location of installed tagged units in the building using a handheld RFID reader programmed to detect the radio frequency signal. The RFID reader transmits the interrogation signal and receives from the RF tags either data associated with the location or an RFID tag ID. Tag information can be stored on a database or on blueprints.

### SUMMARY OF INVENTION

EAS tags and RFID labels used separately or in combination can be used for the purpose of locating critical systems in residential, or commercial construction. Tags/labels can be applied manually at the site by the contractors or they can be installed on parts or units by the manufacturers before shipment. Search criteria for the tags/labels can be stored in databases or on blueprints. Signals from the tags/labels can be detected by a handheld reader by repair or maintenance personnel to locate electrical, heating, plumbing fixtures, or hazardous materials within walls, floors or ceilings of a structure saving large sums of time and damage to buildings especially in situations where multiple crews or subcontractors are present at a construction site.

For the purpose of industrial applications the combination of EAS tags and RFID labels may be desired as stated in the above statement of residential and commercial applications with the inclusion of printed bar coding to facilitate further identification. Tags/labels can be used to locate and identify electrical, heating, plumbing, and hazardous materials in walls, floors, or ceilings of industrial sites. Color-coded tags provide easy identification of basic systems. Data storage in RFID labels provide coded information about any marked locations, systems or units. Search criteria for the tags/labels can be stored in databases and/or on blueprints.

### BRIEF DESCRIPTION OF DRAWINGS

FIGS. 1-5 represent the icons identifying markers used to locate critical systems within buildings. EAS or RFID tags could bear these icons along with color-coding for easy visual identification upon location. FIG. 1 represents electrical. FIG. 2 indicates water/plumbing. FIG. 3 indicates a heating fixture or unit. FIG. 4 indicates hazardous materials.

FIGS. 5-7 represent the EAS/RFID reader. FIG. 5 shows a top view of the scanning LED lights that indicate when a tag has passed through the scan field and then pinpoint the location of the tag. FIG. 6 shows a front view. FIG. 7 is a side view showing the handle and trigger. Industrial model will have a more sophisticated LCD display and keypad entry with optional bar code reader. FIG. 8 is a example model of a tag installed on an electrical box inside a wall.

### DETAILED DESCRIPTION

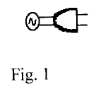

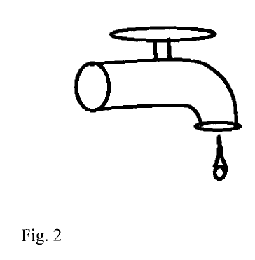

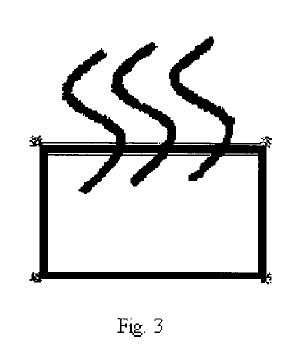

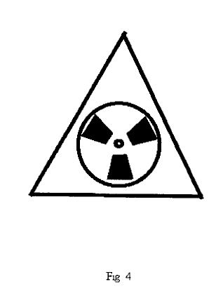

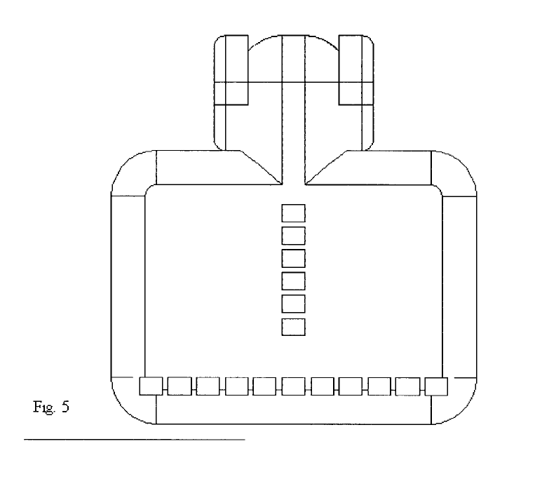

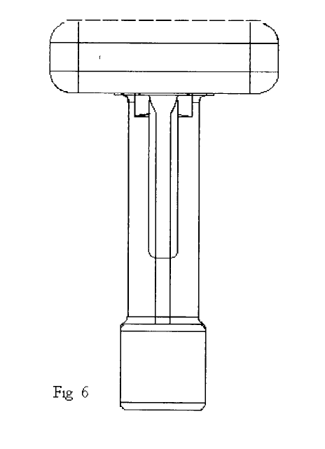

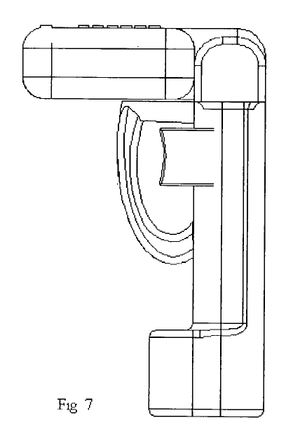

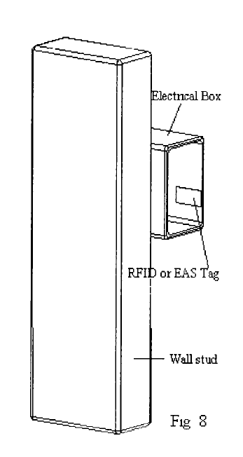

This invention employs the existing EAS and RFID technology to develop a predefined system that encompasses certain disciplines to standardize the placement of Locator Tags in commercial, industrial, and residential applications. When used in Commercial or industrial applications time and labor can be saved by the speed and efficiency with which priority junction boxes, electrical control boxes or valves can be located within new construction or existing building systems. Electrical systems will be marked with a tag labeled with an easy to identify visual symbol as in FIG. 1. Plumbing/water systems will be marked as in FIG. 2. Heating systems will be marked as in FIG. 3. And Hazardous materials will be marked as in FIG. 4. Labels can also be color coded for further ease in visual identification: Blue: water; Green: electrical; Red: heat; and Orange: hazard. For industrial applications bar-coding identification may also be added if desired, for further identification at the location site. Data stored in the tags will enable personnel to locate tagged systems quickly and easily using a handheld RFID reader (FIGS. 5-7). The RFID reader, when swept over an area will display a LED readout to indicate if a tag has entered the field (FIG. 5). If an optional “tear-off” secondary tag is included for industrial applications, personnel can remove the tear-off tag and apply it to blueprints to indicate locations of tagged systems. Tagged system data can also be stored on databases. This method will allow personnel to locate systems and gather stored and labeled data from the tags, saving time and frustration of looking for systems and units within a construction site or building. For residential construction applications contractors can tag units for easy location by subcontractors. Drywall subcontractors can find electrical boxes by scanning an area with the RFID reader. The LED display will identify the location a box to mark the area of drywall to cut out. Lost boxes that are covered over by drywall applicators can be found, saving time and damage to the building.

1. Whereas the EAS and RFID technology is well known within the art what is claimed here is the adaptation of the technology to the field of residential, commercial, and industrial construction. What is claimed is: EAS and/or RFID tags adapted for use in residential, commercial, and industrial construction and building maintenance applications. This method uses a corresponding reader to identify the locations of the tags and/or retrieve stored data from RFID tags The Reader transmits an interrogation signal and receives from the tags either an EAS magnetic signal, data associated with the location and/or an RFID tag ID.

2. The system of claim 1 when applied to the field of residential construction will operate as follows: EAS tags, applied to units at the site or preinstalled by manufacturers will mark installed priority systems. Priority systems tags will be visually labeled in two ways:a.Icons for water, electricity, heat, or other trade symbols.b.Color-coding: Blue for water, red for heat, green for electricity, orange for hazard.As multiple sub-contractors enter the construction site the RFID reader is used to scan ceilings, walls, and floors for junction boxes, electrical boxes, plumbing, heating and cooling items, and other high priority systems that are visually hidden during construction. The LED display will mark the placement of tags on electrical boxes behind drywall. The RFID reader finds the location of the tags which are placed in predefined, standard locations on the boxes to pinpoint the precise area to start to cut. Plumbing and heating systems can be marked and found in a similar manner.

3. The system of claim 1 when applied to commercial construction can be applied as in claim 2 with the addition RFID tags and visual bar code identification with tear off tabs that can be added to blueprints for further ease of identification. RFID readers scan tags to identify locations of priority systems and gather additional stored data from RFID tags. The RFID reader, when used in commercial applications may contain bar code reader capability.

4. The system of claim 1 when used in commercial applications for maintenance purposes can locate and identify priority systems among multiple system configurations in walls, floors, and ceilings. EAS and/or RFID tags applied during construction or installation can identify wiring, electrical boxes, heating systems, and plumbing/water systems for building maintenance personnel through and around barriers of drywall and other building and mechanical systems. Visual icons as stated in claim 2 and bar coding as stated in claim 3 add further identification information. The RFID reader as described in claim 3 is used to scan and locate systems and gather data from tags. Data can be stored on blueprints and/or in databases.

5. The system of claim 1 when used in industrial applications can be applied as in claim 4. Tagged systems in floors, ceilings, and walls may contain data, visual icons, color coding, and bar coding, as stated in claim 2 with the addition of a hazard icon to indicate the location of hazardous materials and any trade symbols that may apply.
